(19) United States
(12) Patent Application Publication
(10) Pub. No.: US 2010/0103173 A1
(43) Pub. Date: Apr. 29, 2010

(54) REAL TIME OBJECT TAGGING FOR INTERACTIVE IMAGE DISPLAY APPLICATIONS

(76) Inventors: Minkyu LEE, Ringoes, NJ (US); Wonsuck LEE, Basking Ridge, NJ (US); Jaesik LEE, Bridgewater, NJ (US)

Correspondence Address: BROSEMER, KOLEFAS & ASSOCIATES, LLC (ALU), 1 BETHANY ROAD, BUILDING 4 - SUITE # 58, HAZLET, NJ, 07730, US

(21) Appl. No.: 12/258,652

(22) Filed: Oct. 27, 2008

(51) Int. Cl. G06T 15/20

(52) U.S. Cl. 345/427

(57) ABSTRACT

Apparatus and methods that track the location of an object within a video image at the time of capture of the video image are described. The location of the object within each frame can be recorded as meta-data for the video image so that when the video image is played back, a viewer can select the object using suitable interaction means and be linked through to a source of additional information about the object, such as a product website or the like. A device emitting radio frequency (RF) signals is attached to an object that is to be identified and tracked within a video image. Using an RF receiver with multiple antennas and applying trilateration techniques, the object's location within the video image is determined in real time and recorded as the video image is recorded. Where multiple objects are to be tracked, each object is provided with a radio device having a unique ID and the location of each device within the video image is recorded. The described solution automates an otherwise manual, error-prone and time-consuming process.

### FIELD OF THE INVENTION

The present invention relates to the field of interactive image display, and more specifically to apparatus and methods relating to the real-time tagging, positioning, and tracking of objects for interactive image display applications such as interactive television.

### BACKGROUND INFORMATION

Object identification and hyperlink tagging in video media allows a viewer to learn more about displayed objects by selecting an object and being linked to a website with additional information about the object. This provides sponsors of a television program or a movie production with a means to effectively embed advertising in a program or to display advertisements that will allow interested viewers to learn more about products or services displayed therein.

Currently, no object tagging or tracking procedures are considered at the time of filming. The object identification and tagging in the video medium is done at the post-editing stage. This task is typically done by a human manually entering the object information in a database. A more automated approach has been to use image recognition technology to track the object of interest in the captured video stream. This, however, is more error-prone even with current state-of-the-art image processing algorithms.

### SUMMARY OF THE INVENTION

The present invention is directed to apparatus and methods that track the location of an object within a video image at the time of capture of the video image. The location of the object within each frame can be recorded as meta-data for the video image so that when the video image is played back, a viewer can select the object using suitable interaction means and be linked through to a source of additional information about the object, such as a product website or the like. Preferably, the present invention allows multiple objects in an image to be individually tracked and identified.

In accordance with an exemplary embodiment of the present invention, a device emitting radio frequency (RF) signals is attached to an object that is to be identified and tracked within a video image. Using an RF receiver with multiple antennas and applying trilateration techniques, the object's location within the video image is determined in real time and recorded as the video image is recorded. Where multiple objects are to be tracked, each object is provided with a radio device having a unique ID and the location of each device within the video image is recorded.

Using a projection algorithm, positions of the objects in the 3-D field can be mapped to a set of pixels on the 2-D screen on which the image is displayed. The coordinate information, the frame number of the filmed video, the ID of the radio device, and other relevant or useful information can be stored in a database, as meta-data, or in any appropriate form, at the time of recording.

In a further exemplary embodiment, a camera capturing an image containing the tagged object is also provided with RF emitting devices which allow for the determination of the camera position and orientation using trilateration techniques. Using additional camera information such as focal length and field of vision, the 2-D virtual screen representing the captured image can be derived.

The aforementioned and other features and aspects of the present invention are described in greater detail below.

### BRIEF DESCRIPTION OF THE DRAWINGS

FIG. 1 is a high-level block diagram of an exemplary embodiment of an object tagging system in accordance with the present invention.

FIG. 2 is a high-level flow chart illustrating the operation of the system of FIG. 1.

FIG. 3 is a schematic representation of a trilateration technique used in an exemplary embodiment of the present invention.

FIGS. 4A through 4D diagrams for illustrating an exemplary technique of mapping the three-dimensional location of an object onto a virtual, two-dimensional screen representative of an image captured by a camera.

### DETAILED DESCRIPTION

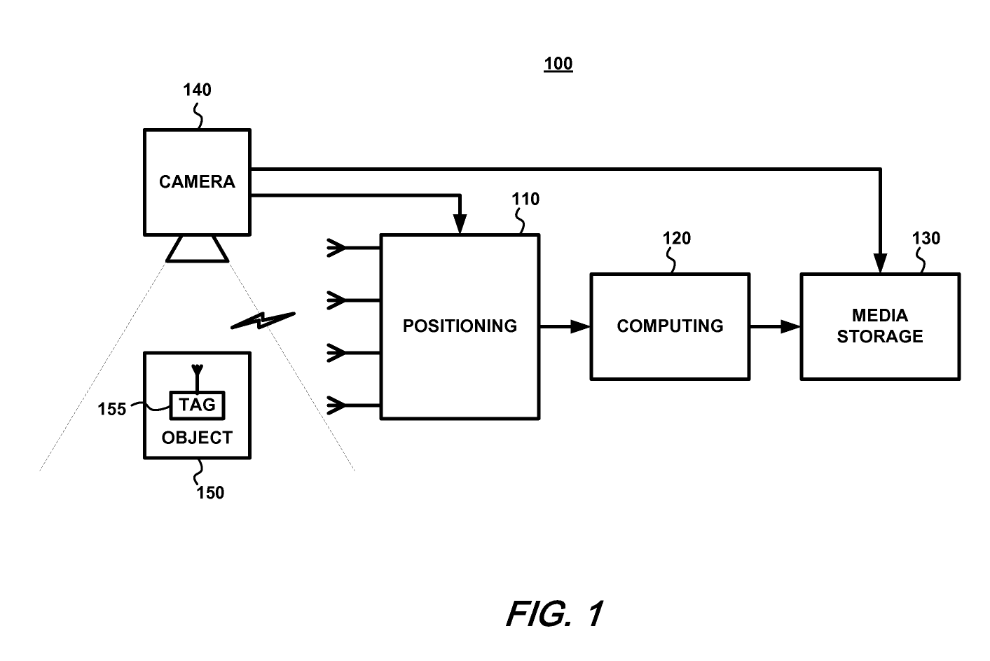

FIG. 1 is a block diagram of an exemplary embodiment of an object tagging system 100 in accordance with the present invention. The system 100 comprises a positioning block 110, a computing block 120, and media storage 130. The positioning block 110 tracks and determines positional information relating to a camera 140 and one or more objects 150.

As contemplated in the exemplary system 100, each object 150 is provided with a radio device or tag 155 that allows the positioning block 110 to locate the object and track its position in real time using trilateration techniques, described below in greater detail. Any of a variety of suitable radio technologies, including, for example, RFID, Bluetooth, or UWB, can be exploited for this purpose. The tag 155 may be an active device which emits a signal under its own power, or it may be a passive device which emits a signal derived from a signal with which it is illuminated. Where multiple objects 150 are to be tagged, each tag 155 preferably emits a unique ID to allow individual tracking of the multiple objects.

As the camera 140 captures images of a scene including the tagged object 150, the object's location in three dimensions is determined by the positioning block 110. For determining the location of the object 150 with trilateration, the positioning block 110 uses multiple antennas for receiving signals from the tag 155. (An additional, emitting antenna may be included for implementations using passive tags.) In addition, the location, shooting angle, focal length, and/or field-of-view of the camera 140 is provided to the positioning block 110. The camera information can be provided to the positioning block 110 over a dedicated interface (wireless or hard-wired) or, like the object 150, the camera 140 may have one or more tags attached thereto, with the tags providing the camera information. An exemplary trilateration arrangement in which the camera is provided with multiple tags is described below. In a further exemplary embodiment, the relevant camera information can be determined by the camera itself or by data collection apparatus associated with the camera and sent therefrom to the positioning block.

The camera information and object location information are provided in real time to the computing block 120. Using a projection algorithm described in greater detail below, the computing block maps the three-dimensional object location information onto a two-dimensional field representing the viewing screen of the captured video image. The location of the tagged object 150 within a scene can be represented in terms of pixel locations in the captured image.

The 2D location information of the tagged object 150 within each frame of a captured video stream is provided and recorded in the media storage 130. For multiple tagged objects, the location information for each object is associated with the object's ID. Each tagged object is associated with a hyperlink so that when the viewer of the video stream points to and selects the object (with a suitable interaction device such as, for example, a mouse or a television remote control), the user can navigate to a website with additional information about the object.

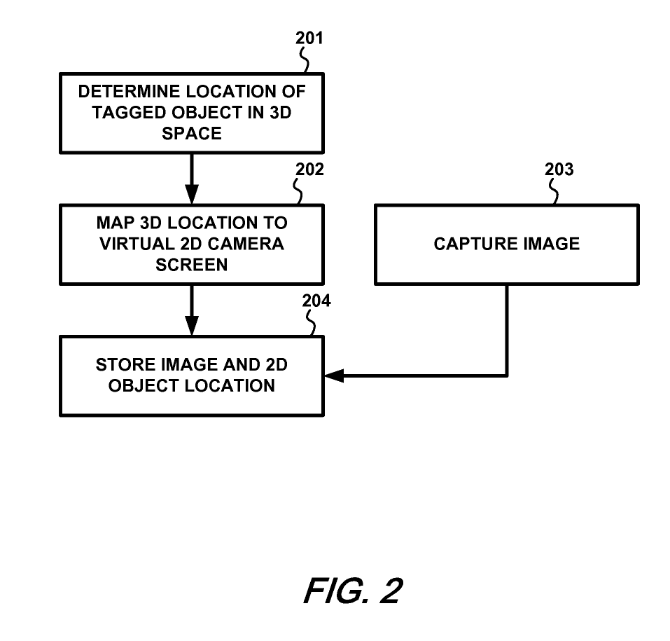

FIG. 2 is a high-level flow chart illustrating an exemplary method in accordance with the present invention. As mentioned above, the location of the tagged object in three-dimensional space is first determined, at step 201. At step 202, the 3D location of the object is mapped onto a two-dimensional virtual screen representative of the image captured by a camera viewing a scene containing the object. The processing of the object location takes place while the image is captured, as represented by step 203. The location information and the image are recorded at step 204. Additional information may also be recorded, including, for example, object ID, time, and frame number, among others. The data and image recording are preferably done simultaneously.

Exemplary techniques for carrying out the steps illustrated in FIG. 2 will now be described in greater detail.

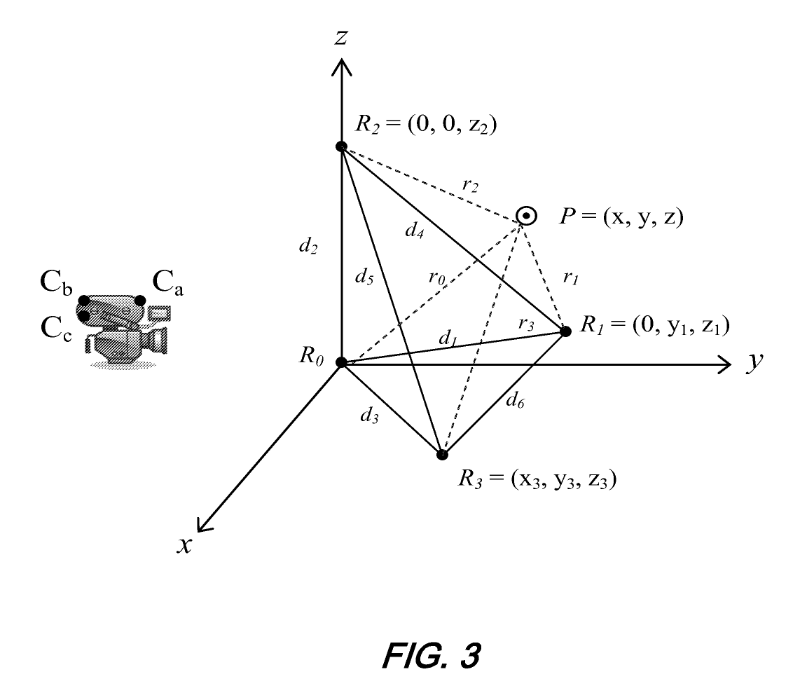

An exemplary arrangement for determining the coordinates in three-dimensional space of an object will now be described with reference to FIG. 3. The points R₀, R₁, R₂, and R₃ are stationary, known reference points from which distances to any RF transmission point, P, can be measured. In the exemplary system described above, the points R₀, R₁, R₂, and R₃ represent the locations of antennas receiving emissions from an RF tag located at point P. The receiving antennas are used in a time difference of arrival (TDOA) scheme in which the differences in the times of arrival at the antennas of a signal emitted from the tag are used to determine the distances from each antenna to the tag.

R₀ is treated as the origin of the Cartesian coordinate system and the line R̅₀̅R̅₁̅ is in the yz-plane. The line R̅₀̅R̅₂̅ is on the z-axis. R₁ and R₃ can be placed anywhere in the domain except on the z-axis. In an exemplary embodiment, the points R₁, R₂, and R₃ are on the y, z, and x axes, equidistant from the origin R₀ of the 3 dimensional Cartesian coordinate system.

For an arbitrary transmission point P=(x,y,z), r₀, r₁, r₂, and r₃ are the distances between point P and points R₀, R₁, R₂, and R₃, respectively, and are determined using the aforementioned TDOA technique. The RF signal receiving points and the transmission points can be arranged so as to have non-negative coordinates by proper placement of R₀, R₁, R₂, and R₃.

The coordinates of the reference points can be represented by d₁, d₂, d₃, d₄, d₅ and d₆, the distances between the reference points. These distances are fixed and known. The angles among the line segments connecting reference points can be obtained from basic trigonometric relationships, as follows:

$$α ≡ ∠ {R}_{1} {R}_{0} {R}_{2} = arccos ( \frac{{d}_{1}^{2} + {d}_{2}^{2} - {d}_{4}^{2}}{2 {d}_{1} {d}_{2}} ) . \qquad ( 1 )$$

Then, the coordinates R₁(0,y₁,z₁) and R₂(0,0,Z₂) are given by:

$${y}_{1} = {d}_{1} cos ( \frac{π}{2} - α ) \\ {z}_{1} = {d}_{1} sin ( \frac{π}{2} - α ) \\ {z}_{2} = {d}_{2} . \qquad ( 2 )$$

The coordinates of R₃(x₃,y₃,z₃) can be obtained by solving the following equations:

d₃²=x₃²+y₃²+z₃²

d₅²=x₃²+y₃²+(z₃−z₂)²

d₆²=x₃²+(y₃−y₁)²+(z₃−z₁l)². (3)

These equations yield the following solutions:

$${x}_{3} = \sqrt{\frac{{d}_{3}^{2} - {[ \begin{matrix}{d}_{5}^{2} - {d}_{6}^{2} + {y}_{1}^{2} + {z}_{1}^{2} - {z}_{2}^{2} + \\ ( {z}_{2}^{2} + {d}_{3}^{2} - {d}_{5}^{2} ) ( 1 - {z}_{1} / {z}_{2} )\end{matrix} ]}^{2}}{4 {y}_{1}^{2}} - \frac{{[ {z}_{2}^{2} + {d}_{3}^{2} - {d}_{5}^{2} ]}^{2}}{4 {z}_{2}^{2}}} \\ {y}_{3} = \frac{{d}_{5}^{2} - {d}_{6}^{2} + {y}_{1}^{2} + {z}_{1}^{2} - {z}_{2}^{2} + ( {z}_{2}^{2} + {d}_{3}^{2} - {d}_{5}^{2} ) ( 1 - {z}_{1} / {z}_{2} )}{2 {y}_{1}} \\ {z}_{3} = \frac{{z}_{2}^{2} + {d}_{3}^{2} - {d}_{5}^{2}}{2 {z}_{2}} \qquad ( 4 )$$

Once the coordinates of the reference points R₁, R₂ and R₃ are determined, the coordinates of point P=(x,y,z) can be obtained by solving the following system of equations:

r₀²=x²+y²+z²

r₁²=x²+(y−y₁)²+(z−z₁)

r₂²=x²+y²+(z−z₂)²

r₃²=(x−x₃)²+(y−y₃)²+(z−z₃)² (5)

This system of equation yields the following solution:

$$x = \pm \sqrt{{r}_{0} - \frac{{[ \begin{matrix}{r}_{0} - {r}_{1} + {y}_{1}^{2} + {z}_{1}^{2} - \\ ( {r}_{0}^{2} {z}_{1} - {r}_{2}^{2} {z}_{1} ) / {z}_{2} - {z}_{1} {z}_{2}\end{matrix} ]}^{2}}{4 {y}_{1}^{2}} - \frac{{[ {r}_{0}^{2} - {r}_{2}^{2} + {z}_{2}^{2} ]}^{2}}{4 {z}_{2}^{2}}} \\ y = \frac{{r}_{0}^{2} - {r}_{1}^{2} + {y}_{1}^{2} + {z}_{1}^{2} - ( {r}_{0}^{2} {z}_{1} - {r}_{2}^{2} {z}_{1} ) / {z}_{2} - {z}_{1} {z}_{2}}{2 {y}_{1}} \\ z = \frac{{r}_{0}^{2} - {r}_{2}^{2} + {z}_{2}^{2}}{2 {z}_{2}} \qquad ( 6 )$$

The sign of x should be positive due to the assumptions made above.

As such, using the exemplary trilateration technique described, the 3D coordinates of the tagged object (at point P), can be determined from the distances between the receiving antennas (d₁, d₂, d₃, d₄, d₅ and d₆) and the distances between the receiving antennas and the tagged object (r₀, r₁, r₂, and r₃ ).

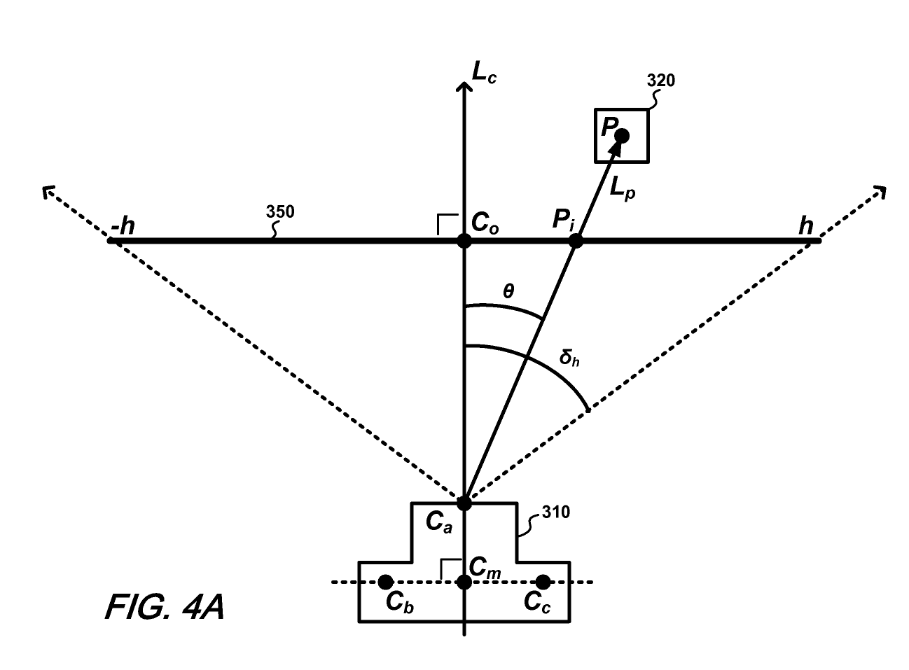

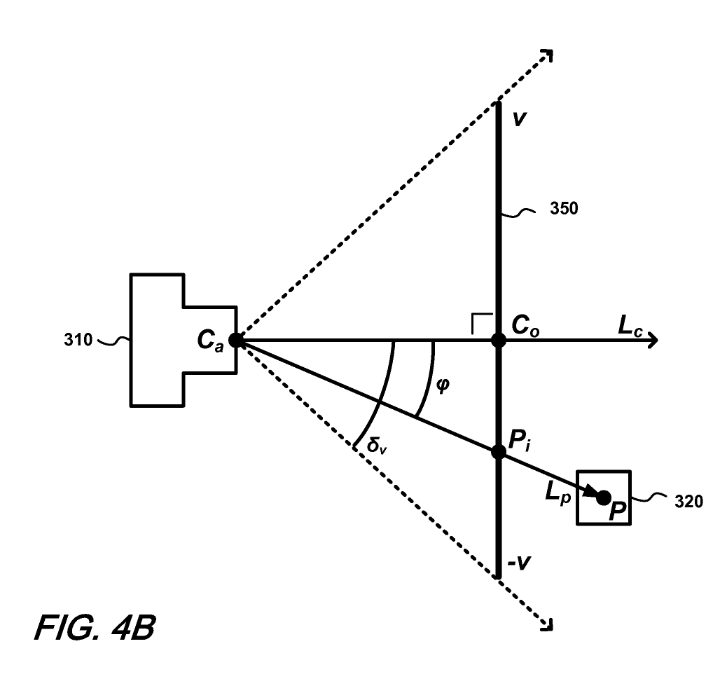

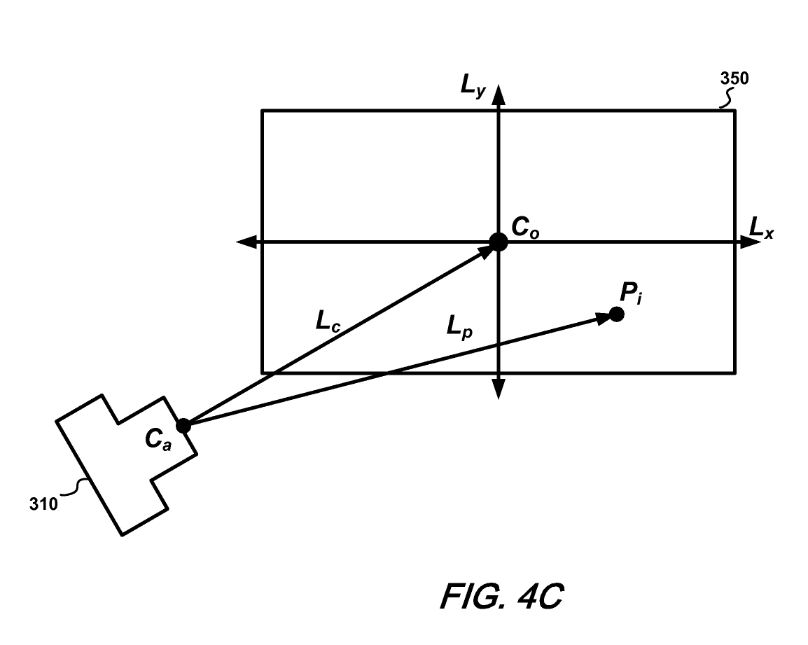

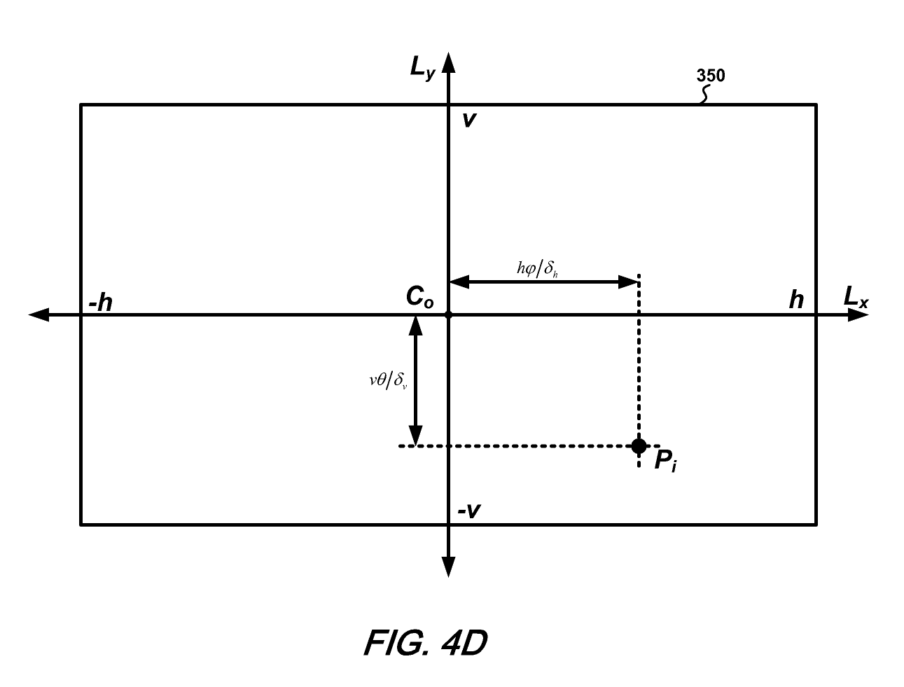

Ultimately, the object appears on a two-dimensional screen, thus, the object coordinates in three-dimensional space should be mapped on a virtual planar surface which represents the screen to be viewed. An exemplary procedure for performing such a mapping will now be described with reference to FIGS. 4A-4D which show a camera 310, a tagged object 320, and a two-dimensional plane or virtual screen 350 representative of the image (still or moving) captured by the camera. FIG. 4A shows a plan view, FIG. 4B an elevation view and FIG. 4C an isometric view of the aforementioned elements. The screen 350 extends horizontally and vertically by dimensions h and v, respectively, about a center point Cₒ.

Three points are shown on the camera 310, Cₐ, C_{b}, and C_{c}, at which emitters, such as the tag used for the object 320 are located, in accordance with an exemplary embodiment of the invention. The coordinates of each of these points, Cₐ=(xₐ,yₐ, zₐ), C_{b}=(x_{b},y_{b},z_{b}), C_{c}=(x_{c},y_{c},z_{c}), can be determined from the distances between these points and the reference points R₀, R₁, R₂, and R₃, using a similar procedure and arrangement as described above for the coordinates of the object 320, P=(xₚ,yₚ,zₚ). With reference to FIG. 1, the same positioning block 110 and receiving antennas used to locate the tagged device(s) 150 can be used for determining the location and orientation of the camera 140. As shown in FIG. 4A, the points C_{b}, and C_{c} are arranged in a line that is substantially perpendicular to a line L_{c} which includes the point Cₐ and is substantially at the center of the field of view of the camera 310. The line L_{c} is also perpendicular to the two-dimensional plane 350 of the scene, which is defined, as shown in FIG. 4C, by the lines Lₓ and L_{y}.

Ideally, the point Cₐ is at the center of the lens of the camera but because of the physical limitations of placing an emitting device there, it is preferably as close as possible, such as centered directly above the lens. In this embodiment, the points C_{b}, and C_{c} are equidistant from the center of the camera lens, in which case, the line L_{c} includes the midpoint between the points C_{b}, and C_{c}, namely, Cₘ=(xₘ,yₘ,zₘ), where xₘ=(x_{b}+x_{c})/2, yₘ=(y_{b}+y_{c})/2, zₘ=(z_{b}+z_{c})/2. The line, L_{c}, through Cₐ and the midpoint Cₘ=(xₘ,yₘ,zₘ) of C_{b} and C_{c}, can be expressed as follows:

$$\frac{x - {x}_{a}}{{x}_{m} - {x}_{a}} = \frac{y - {y}_{a}}{{y}_{m} - {y}_{a}} = \frac{z - {z}_{a}}{{z}_{m} - {z}_{a}} . \qquad ( 7 )$$

Let l, m, n be the directional cosine of the line L_{c}, then they become:

$$l = \frac{{x}_{m} - {x}_{a}}{\sqrt{{( {x}_{m} - {x}_{a} )}^{2} + {( {y}_{m} - {y}_{a} )}^{2} + {( {z}_{m} - {z}_{a} )}^{2}}} \\ m = \frac{{y}_{m} - {y}_{a}}{\sqrt{{( {x}_{m} - {x}_{a} )}^{2} + {( {y}_{m} - {y}_{a} )}^{2} + {( {z}_{m} - {z}_{a} )}^{2}}} \\ n = \frac{{z}_{m} - {z}_{a}}{\sqrt{{( {x}_{m} - {x}_{a} )}^{2} + {( {y}_{m} - {y}_{a} )}^{2} + {( {z}_{m} - {z}_{a} )}^{2}}} \qquad ( 8 )$$

The image of the object point P on the screen 350 is designated as point Pᵢ=(xᵢ,yᵢ,zᵢ). A line Lₚ from the point Cₐ to the object image point Pᵢ=(xᵢ,yᵢ,zᵢ) is:

$$\frac{x - {x}_{a}}{{x}_{i} - {x}_{a}} = \frac{y - {y}_{a}}{{y}_{i} - {y}_{a}} = \frac{z - {z}_{a}}{{z}_{i} - {z}_{a}} . \qquad ( 9 )$$

Because the line L_{c} is perpendicular to the plane 350 and the point Cₒ=(xₒ,yₒ,zₒ) is in the plane 350, the equation of the plane 350 becomes

l(x−xₒ)+m(y−yₒ)+n(z−zₒ)=0. (10)

The center point of the screen plane 350 can be used as the origin of a two-dimensional coordinate system for the screen plane 350. Since the center point Cₒ=(xₒ,yₒ,zₒ) is on the line L_{c}, it satisfies the following:

$$\frac{{x}_{o} - {x}_{a}}{{x}_{m} - {x}_{a}} = \frac{{y}_{o} - {y}_{a}}{{y}_{m} - {y}_{a}} = \frac{{z}_{o} - {z}_{a}}{{z}_{m} - {z}_{a}} . \qquad ( 11 )$$

Another equation is needed to close the system and to determine the coordinates of the point Cₒ. The focal length f of the camera is the distance from the lens of the camera Cₐ to the focal point of the camera, which corresponds to the center point Cₒ. As such:

f=\sqrt{(xₐ−xₒ)²+(yₐ−yₒ)²+(zₐ−zₒ)²}. (12)

Let kₒ be a constant which satisfies:

$$\frac{{x}_{o} - {x}_{a}}{{x}_{m} - {x}_{a}} = \frac{{y}_{o} - {y}_{a}}{{y}_{m} - {y}_{a}} = \frac{{z}_{o} - {z}_{a}}{{z}_{m} - {z}_{a}} = {k}_{o} , \qquad ( 13 )$$

in which case the focal length f and kₒ have the following relationship:

$${k}_{o} = \frac{f}{\sqrt{{( {x}_{m} - {x}_{a} )}^{2} + {( {y}_{m} - {y}_{a} )}^{2} + {( {z}_{m} - {z}_{a} )}^{2}}} . \qquad ( 14 )$$

The coordinates of point Cₒ are:

xₒ=xₐ+kₒ(xₘ−xₐ)

yₒ=yₐ+kₒ(yₘ−yₐ)

zₒ=zₐ+kₒ(zₘ−zₐ) (15)

The coordinates of the object image point Pᵢ can be obtained from the following system of equations:

$$\begin{matrix}l ( {x}_{i} - {x}_{o} ) + m ( {y}_{i} - {y}_{o} ) + n ( {z}_{i} - {z}_{o} ) = 0 & ( 16 ) \\ \frac{{x}_{i} - {x}_{a}}{{x}_{p} - {x}_{a}} = \frac{{y}_{i} - {y}_{a}}{{y}_{p} - {y}_{a}} = \frac{{z}_{i} - {z}_{a}}{{z}_{p} - {z}_{a}} = {k}_{p} & ( 17 )\end{matrix}$$

Eq. 17 follows from the fact the point Pᵢ is on screen 350. The second part of the above equations is valid since the point Pᵢ is on a line connecting point Cₐ and the object point P=(xₚ,yₚ,zₚ). kₚ is a constant which satisfies the line equation. The coordinate of the point Pᵢ becomes:

$$\begin{matrix}{x}_{i} = {x}_{a} + {k}_{p} ( {x}_{p} - {x}_{a} ) \\ {y}_{i} = {y}_{a} + {k}_{p} ( {y}_{p} - {y}_{a} ) , \\ {z}_{i} = {z}_{a} + {k}_{p} ( {z}_{p} - {z}_{a} ) \\ where & ( 18 ) \\ {k}_{p} = \frac{l ( {x}_{o} - {x}_{a} ) + m ( {y}_{o} - {y}_{a} ) + n ( {z}_{o} - {z}_{a} )}{l ( {x}_{p} - {x}_{a} ) + m ( {y}_{p} - {y}_{a} ) + n ( {z}_{p} - {z}_{a} )} . & ( 19 )\end{matrix}$$

Now, we have all the coordinate information for the center point Cₒ and the object image point Pᵢ. A line through these two points is:

$$\begin{matrix}\frac{x - {x}_{o}}{{l}_{io}} = \frac{y - {y}_{o}}{{m}_{io}} = \frac{z - {z}_{o}}{{n}_{io}} , \\ where & ( 20 ) \\ {l}_{io} = \frac{{x}_{i} - {x}_{o}}{\sqrt{{( {x}_{i} - {x}_{o} )}^{2} + {( {y}_{i} - {y}_{o} )}^{2} + {( {z}_{i} - {z}_{o} )}^{2}}} \\ {m}_{io} = \frac{{y}_{i} - {y}_{o}}{\sqrt{{( {x}_{i} - {x}_{o} )}^{2} + {( {y}_{i} - {y}_{o} )}^{2} + {( {z}_{i} - {z}_{o} )}^{2}}} . \\ {n}_{io} = \frac{{z}_{i} - {z}_{o}}{\sqrt{{( {x}_{i} - {x}_{o} )}^{2} + {( {y}_{i} - {y}_{o} )}^{2} + {( {z}_{i} - {z}_{o} )}^{2}}} & ( 21 )\end{matrix}$$

The line equations for Lₓ and L_{y} will give the values of the angles θ and φ shown in FIGS. 4A and 4B. Suppose that the equations of Lₓ and L_{y} are:

$$\begin{matrix}\frac{x - {x}_{o}}{{l}_{1}} = \frac{y - {y}_{o}}{{m}_{1}} = \frac{z - {z}_{o}}{{n}_{1}} , and & ( 22 ) \\ \frac{x - {x}_{o}}{{l}_{2}} = \frac{y - {y}_{o}}{{m}_{2}} = \frac{z - {z}_{o}}{{n}_{2}} . & ( 23 )\end{matrix}$$

The directional cosine of line Lₓ should be proportional to the directional cosine of a line passing through points C_{b} and C_{c} since they are parallel. More precisely the directional cosine, (l_{bc},m_{bc},n_{bc}), of a line through points C_{b} and C_{c} becomes

$${l}_{bc} = \frac{{x}_{b} - {x}_{c}}{\sqrt{{( {x}_{b} - {x}_{c} )}^{2} + {( {y}_{b} - {y}_{c} )}^{2} + {( {z}_{b} - {z}_{c} )}^{2}}} \\ {m}_{bc} = \frac{{y}_{b} - {y}_{c}}{\sqrt{{( {x}_{b} - {x}_{c} )}^{2} + {( {y}_{b} - {y}_{c} )}^{2} + {( {z}_{b} - {z}_{c} )}^{2}}} . \\ {n}_{bc} = \frac{{z}_{b} - {z}_{c}}{\sqrt{{( {x}_{b} - {x}_{c} )}^{2} + {( {y}_{b} - {y}_{c} )}^{2} + {( {z}_{b} - {z}_{c} )}^{2}}} \qquad ( 24 )$$

We then have l₁=kl_{bc},m₁=km_{bc}, and n₁=kn_{bc} for a certain constant k. The equation of line Lₓ can be rewritten as:

$$\frac{x - {x}_{o}}{{l}_{bc}} = \frac{y - {y}_{o}}{{m}_{bc}} = \frac{z - {z}_{o}}{{n}_{bc}} . \qquad ( 25 )$$

To obtain the directional cosine of L_{y} we have two equations:

l₂l_{bc}+m₂m_{bc}+n₂n_{bc}=0, (26)

since Lₓ⊥L_{y}, and

l₂l+m₂m+n₂n=0, (27)

since L_{y} is on the plane 350. This system of equations yields the following solution for the directional cosine of L_{y}:

$${l}_{2} = h \\ {m}_{2} = h \cdot \frac{n \cdot {l}_{bc} - l \cdot {n}_{bc}}{m \cdot {n}_{bc} - {m}_{bc} \cdot n} \\ {n}_{2} = h \cdot \frac{l \cdot {m}_{bc} - m \cdot {l}_{bc}}{m \cdot {n}_{bc} - {m}_{bc} \cdot n} \qquad ( 28 )$$

for a constant h. The equation of line L_{y} becomes

$$\frac{x - {x}_{o}}{m \cdot {n}_{bc} - n \cdot {m}_{bc}} = \frac{y - {y}_{o}}{n \cdot {l}_{bc} - l \cdot {n}_{bc}} = \frac{z - {z}_{o}}{l \cdot {m}_{bc} - m \cdot {l}_{bc}} . \qquad ( 29 )$$

The directional cosine of L_{y} can be rewritten as:

$${l}_{2} = \frac{m \cdot {n}_{bc} - n \cdot {m}_{bc}}{\sqrt{\begin{matrix}{( m \cdot {n}_{bc} - n \cdot {m}_{bc} )}^{2} + \\ {( n \cdot {l}_{bc} - l \cdot {n}_{bc} )}^{2} + {( l \cdot {m}_{bc} - m \cdot {l}_{bc} )}^{2}\end{matrix}}} \\ {m}_{2} = \frac{n \cdot {l}_{bc} - l \cdot {n}_{bc}}{\sqrt{\begin{matrix}{( m \cdot {n}_{bc} - n \cdot {m}_{bc} )}^{2} + \\ {( n \cdot {l}_{bc} - l \cdot {n}_{bc} )}^{2} + {( l \cdot {m}_{bc} - m \cdot {l}_{bc} )}^{2}\end{matrix}}} \\ {n}_{2} = \frac{l \cdot {m}_{bc} - m \cdot {l}_{bc}}{\sqrt{\begin{matrix}{( m \cdot {n}_{bc} - n \cdot {m}_{bc} )}^{2} + \\ {( n \cdot {l}_{bc} - l \cdot {n}_{bc} )}^{2} + {( l \cdot {m}_{bc} - m \cdot {l}_{bc} )}^{2}\end{matrix}}} \qquad ( 30 )$$

Let line L_{IO} be defined by the two points Cₒ and Pᵢ. Then, the angle φ between Lₓ and L_{IO} becomes

φ=arc cos(l₁lᵢₒ+m₁mᵢₒ+n₁nᵢₒ) (31)

The angle θ, between L_{y} and L_{IO} is

θ=arc cos(l₂lᵢₒ+m₂mᵢₒ+n₂nᵢₒ) (32)

Since f, h, and v are readily available, the angles δₕ and δᵥ can be derived as:

$$\begin{matrix}{δ}_{h} = arctan ( \frac{h}{f} ) , and & ( 33 ) \\ {δ}_{v} = arctan ( \frac{v}{f} ) . & ( 34 )\end{matrix}$$

The ratios θ/δᵥ and φ/δₕ are sufficient to determine, respectively, the relative vertical and horizontal positions of the object image point Pᵢ on the screen 350. This is shown in FIG. 4D.

Once the coordinates of the object within the camera image have been determined, as described above, this information along with any other relevant information that may be desired, is recorded, as discussed above with reference to FIG. 2.

The present invention can be used in a variety of applications. Consider an illustrative application of the present invention in which a movie studio is filming a scene in Central Park in which the main actor and actress are sitting on a bench. A sponsor of the movie is a well-known fashion company that wants to advertise a new handbag held by the actress on her lap. The fashion company wants to provide a direct link to their online shop if a viewer moves the pointer, available with an interactive TV set, to the proximity of the handbag. At the time of filming, a Bluetooth radio device, or the like, is placed inside the handbag. Four radio antennas placed around the bench receive the radio signals from the Bluetooth device and send it to a laptop computer. Simultaneously, the video camera sends frame numbers to the laptop computer where the concurrently generated object position and frame numbers are associated and stored in a database. The present invention allows the producer to build a database of all the necessary information regarding the location of the object (i.e., handbag) in the video screen, its identity, and the frame number. Advantageously, this can be done without human intervention or error-prone image recognition technologies. The trilateration positioning device, video camera, and computer can communicate over wired or wireless connections.

The present invention provides accurate means of object tracking and tagging in real time for interactive TV applications, streaming video, or the like. This eliminates time consuming and/or error-prone post processing steps involved in locating objects in the video. It is a useful tool for a variety of applications such as advertising and marketing in interactive video. Additionally, the present invention can help advertisers track the amount of time that their products are seen on the screen, and provide other useful information.

Note that while the apparatus and methods of the present invention are most advantageously used in conjunction with video or moving images, the present invention can just as readily be applied to still imaging as well, where individual images are captured.

It is understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1 A method of tracking an object in an image comprising:
determining the location of the object in three-dimensional space based on trilateration of emissions from a radio frequency (RF) tag device attached to the object;
determining the location and orientation of a camera;
mapping the location of the object from three-dimensional space onto a two-dimensional virtual screen defined by the location and orientation of the camera; and
recording the mapped location of the object.

2. The method of claim 1, comprising:
recording an image containing the object, wherein the recording of the image and the recording of the mapped location of the object occur simultaneously.

3. The method of claim 1, wherein the RF emissions from the tag device contain identification information associated with the object.

4. The method of claim 1, wherein the object is associated with a hyperlink.

5. The method of claim 1, wherein determining the location and orientation of the camera is based on trilateration of emissions from a plurality of RF tag devices attached to the camera.

6. The method of claim 1, wherein the image comprises a video image.

7. The method of claim 2, wherein the mapped location of the object and the image are recorded in the same medium.

8. A system for tracking an object in an image comprising:
a positioning apparatus, the positioning apparatus determining the location of the object in three-dimensional space based on trilateration of emissions from a radio frequency (RF) tag device attached to the object, the positioning apparatus also determining the location and orientation of a camera;
a computing apparatus, the computing apparatus mapping the location of the object from three-dimensional space onto a two-dimensional virtual screen defined by the location and orientation of the camera; and
a recording apparatus, the recording apparatus recording the mapped location of the object.

9. The system of claim 8, wherein the recording apparatus records an image containing the object, and wherein the recording of the image and the recording of the mapped location of the object occur simultaneously.

10. The system of claim 8, wherein the RF emissions from the tag device contain identification information associated with the object.

11. The system of claim 8, wherein the object is associated with a hyperlink.

12. The system of claim 8, wherein the positioning apparatus determines the location and orientation of the camera based on trilateration of emissions from a plurality of RF tag devices attached to the camera.

13. The system of claim 8, wherein the image comprises a video image.

14. The system of claim 9, wherein the mapped location of the object and the image are recorded in the same medium.
